(19) United States
(12) Patent Application Publication
(10) Pub. No.: US 2005/0015574 A1
(43) Pub. Date: Jan. 20, 2005

(54) Processor and method capable of executing instruction sets with different lengths

(75) Inventor: Ming-Chuan Huang, Fongyuan City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsin-chu (TW)

(21) Appl. No.: 10/742,846

(22) Filed: Dec. 23, 2003

(30) Foreign Application Priority Data
Jul. 16, 2003 (TW) 092119393

(51) Int. Cl. G06F 9/30

(52) U.S. Cl. 712/209; 712/227

(57) ABSTRACT

A processor and method capable of executing instruction sets with different lengths is disclosed. The instruction sets include at least an N-bit instruction set and a 2N-bit instruction set. The 2N-bit instruction set includes an instruction set switch instruction (ISSI-2N-N). The N-bit instruction set includes an instruction set switch instruction (ISSI-N-2N). When the ISSI-2N-N is fetched, an instruction decoding device and an instruction executing device are switched to an N-bit mode. When the ISSI-N-2N is fetched, the instruction decoding device and the instruction executing device are switched to a 2N-bit mode. In the N-bit mode, the instruction decoding device decodes a fetched 2N bit word as two N-bit instructions and the instruction executing device executes the two decoded N-bit instructions. In the 2N-bit mode, the instruction decoding device decodes a fetched 2N bit word as a 2N-bit instruction and the instruction executing device executes the decoded 2N-bit instruction.

### BACKGROUND OF THE INVENTION

1. Field of the Invention

The present invention relates to the technical field of processors and, more particularly, to a processor and method capable of executing instruction sets with different lengths in a computer system.

2. Description of Related Art

Typically, a processor is provided with 32-bit/16-bit instruction modes and capable of switching between the two modes to save required memory for storing programming codes. U.S. Pat. No. 5,758,115 granted to Nevill and Edward Colles for an “Interoperability with multiple instruction sets” uses T bit of program status register to determine whether the processor is 32-bit or 16-bit instruction mode and uses an branch instruction to change values of the T bit. The instruction modes are changed as shown in FIG. 1. When the branch instruction 220 is performed to branch to a target address Badd(1) that is stored at 16-bit instruction address (branch target address Bit0=1) so as to execute the 16-bit instruction. The T bit is switched by +1 (Bit0=1) to inform the processor to be in the 16-bit instruction mode. The branch instruction 240 is performed to branch to a target address Badd(2) (Bit0=0) that is at 32-bit instruction address so as to execute the 32-bit instruction. Such a mode switch is employed for processors of some processors series. However, such a mode switch requires different memory blocks to separately store 32-bit and 16-bit instructions, other than the same memory block to integrally store the instructions. Therefore, programming code storage cannot be optimized. In addition, to complete such a mode switch requires not only one Branch instruction but also 4-8 instructions. For example, as shown in FIG. 2, there is an assembly code segment that instructs an processor which is in an 32-bit mode to switch to a 16-bit mode, and subsequently to switch to the 32-bit mode again. It requires at least two 32-bit instructions and two 16-bit instructions; i.e., it requires a memory space of 2*32+2*16=96 bits. These additional instructions are used for loading the destination address of the target address. In addition to the poor code storage space, such a mode switch technology adds the required memory space at switching.

As to the aforementioned problem, U.S. Pat. No. 6,209,079B1 granted to Otani, et al. for a “Processor for executing instruction codes of two different lengths and device for input the instruction codes” has provided a solution by applying the most significant bit (MSB) of an instruction code to determine whether the processor is in 32-bit or 16-bit instruction mode. As shown in FIG. 3, the 32-bit word contains a 32-bit instruction if the MSB on 32-bit boundary is ‘1’ and two 16-bit instructions if the MSB on 32-bit boundary is ‘0’. Two 16-bit instructions are performed sequentially if the MSB of 16-bit instruction B is ‘1’. Such an instruction mode switch is used in the some processors series. In this case, the 32-bit and 16-bit instructions can be stored in the same block to increase the code density. However, when a branch or jump instruction is performed, it needs to be careful to avoid jumping to the odd half word portion of a 32-bit instruction. Because the last odd half word instruction is not executable, it may cause unpredictable error. Therefore, the jump address is required to be limited to a word boundary or 32-bit boundary. The return addresses for branch-and-link and jump-and-link instructions are also required to be limited to a word boundary and 32-bit boundary. Such a limitation adds inconvenience in use. In addition, such an instruction mode switch requires using 1 bit to separate 16-bit instruction from 32-bit instruction in an instruction set, and it cannot support the immediate addressing mode in the 16-bit instruction mode. Therefore, the conventional 32-bit/16-bit instruction mode switching still encounters many problems, and thus it is desirable to provide an improved processor to mitigate and/or obviate the aforementioned problems.

### SUMMARY OF THE INVENTION

The object of the present invention is to provide a processor and method capable of executing instruction sets with different lengths, thereby avoiding complicated problem presented on the word boundary or 32-bit boundary caused by the prior jump address limitation, and increasing code density.

According to a feature of the present invention, there is provided a processor capable of executing instruction sets with different lengths. The instruction sets with different lengths includes at least an N-bit instruction set and a 2N-bit instruction set (N is positive integer). Each instruction of the N-bit instruction set consists of an N-bit word. Each instruction of the 2N-bit instruction set consists of a 2N-bit word. The 2N-bit instruction set includes an ISSI-2N-N (instruction set switch instruction-2N-N). The N-bit instruction set includes an ISSI-N-2N (instruction set switch instruction-N-2N). The processor includes an instruction input device, an instruction fetching device, an instruction decoding device, an instruction executing device and an instruction set switching controller. The instruction input device includes a memory space having a width of 2N-bit for storing a plurality of 2N-bit words representing instructions. The instruction fetching device fetches a 2N-bit word from the instruction input device. The instruction decoding device decodes the 2N-bit word fetched by the instruction fetching device. The instruction executing device executes a N-bit instruction or a 2N-bit instruction which are outputted by the instruction decoding device. The instruction set switching controller is coupled to the instruction fetching device for switching the instruction decoding device and the instruction executing device to an N-bit mode for execution when the ISSI-2N-N instruction is fetched or switching the instruction decoding device and the instruction executing device to a 2N-bit mode for execution when the ISSI-N-2N instruction is fetched. In the N-bit mode, the instruction decoding device decodes the 2N bit word fetched by an instruction fetching device of the processor as two N-bit instructions and following the instruction executing device executes the two N-bit instructions. In the 2N-bit mode, the instruction decoding device decodes the 2N bit word fetched by the instruction fetching device of the processor as a 2N-bit instruction and the instruction executing device executes the 2N-bit instruction.

According to another feature of the present invention, there is provided a method for executing instruction sets with different lengths in a processor. The method includes the following steps: providing a plurality of 2N-bit words representing instructions; fetching one of the plurality of 2N-bit words in order to be decoded by an instruction decoding device and executed by an instruction executing device; when the ISSI-2N-N is fetched, switching the instruction decoding device and the instruction executing device to an N-bit mode for execution, such that the instruction decoding device decodes the one 2N-bit word fetched as two N-bit instructions and the instruction executing device executes the two N-bit instructions When the ISSI-N-2N is fetched, switching the instruction decoding device and the instruction executing device to 2N-bit mode for execution, such that the instruction decoding device decodes the one 2N-bit word and the instruction executing device executes the 2N-bit instruction.

According to a further feature of the present invention, there is provided a processor capable of executing instruction sets with different lengths. The instruction sets with different lengths are represented by 2ⁱ*N-bit instruction set (0≦i≦M, and N, M are positive integer). Instructions of the 2ⁱ*N-bit instruction set is 2ⁱ*N-bit word. The 2ⁱ*N-bit instruction set includes at least one 2ⁱ*N to 2^{k}*N instruction set switch instructions (0≦k≦M, k≠i). The processor comprises: an instruction input device, which includes a memory space having a width of 2^{M}*N-bit for storing a plurality of 2^{M}*N-bit words representing instructions; an instruction fetching device, which fetches a 2^{M}*N-bit word from the instruction input device When the processor is in 2ⁱ*N-bit mode; the instruction decoding device, which decodes the 2ⁱ*N-bit word and outputs a 2ⁱ*N-bit instruction to instruction executing device, which executes the decoded 2ⁱ*N-bit instruction. The instruction set switching controller, which is coupled to the instruction fetching device for switching the instruction decoding device and the instruction executing device to a 2^{k}*N-bit mode for execution when the 2ⁱ*N to 2^{k}*N instruction set switch instruction is fetched, wherein in the 2^{k}*N-bit mode, the instruction decoding device decodes the 2^{k}*N bit word fetched by the instruction fetching device as at least one 2^{k}*N-bit instruction and the instruction executing device executes the at least one decoded 2^{k}*N-bit instruction (K=M).

According to another further feature of the present invention, there is provided a method for executing instruction sets with different lengths. The method includes the following steps: providing a plurality of 2^{M}*N-bit words representing instructions; fetching one of the plurality of 2^{M}*N-bit words in order to be decoded by an instruction decoding device and executed by an instruction executing device; and when the 2ⁱ*N to 2^{k}*N bit instruction set switch instruction is fetched, switching the instruction decoding device and the instruction executing device to a 2^{k}*N-bit mode for execution, such that the instruction decoding device decodes the one 2^{k}*N-bit word in order and the instruction executing device executes the one 2^{k}*N-bit instruction in order.

### BRIEF DESCRIPTION OF THE DRAWINGS

FIG. 1 s a conceptual chart of a typical instruction mode switching process;

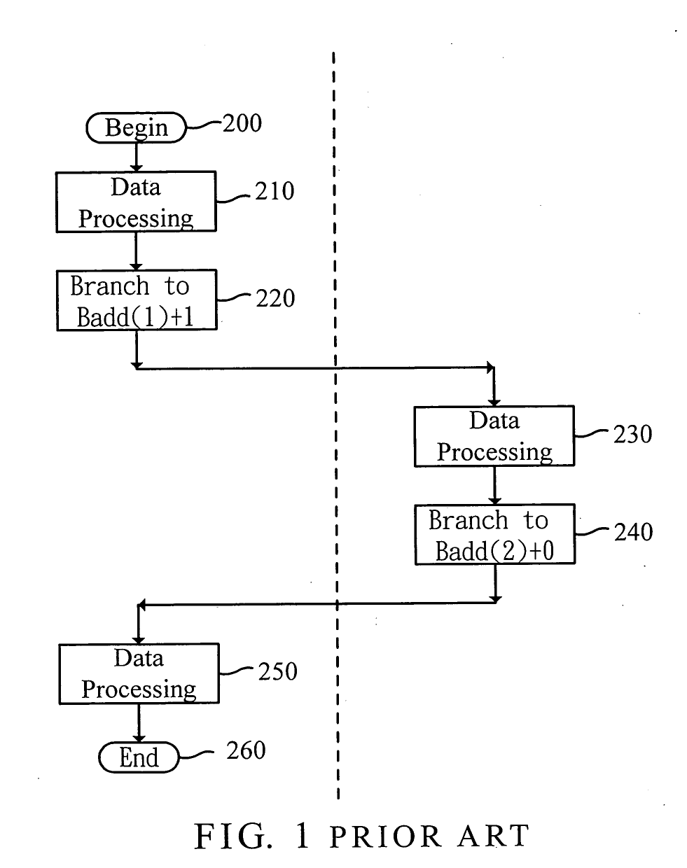

FIG. 2 is assembly codes of a typical instruction mode switching for FIG. 1;

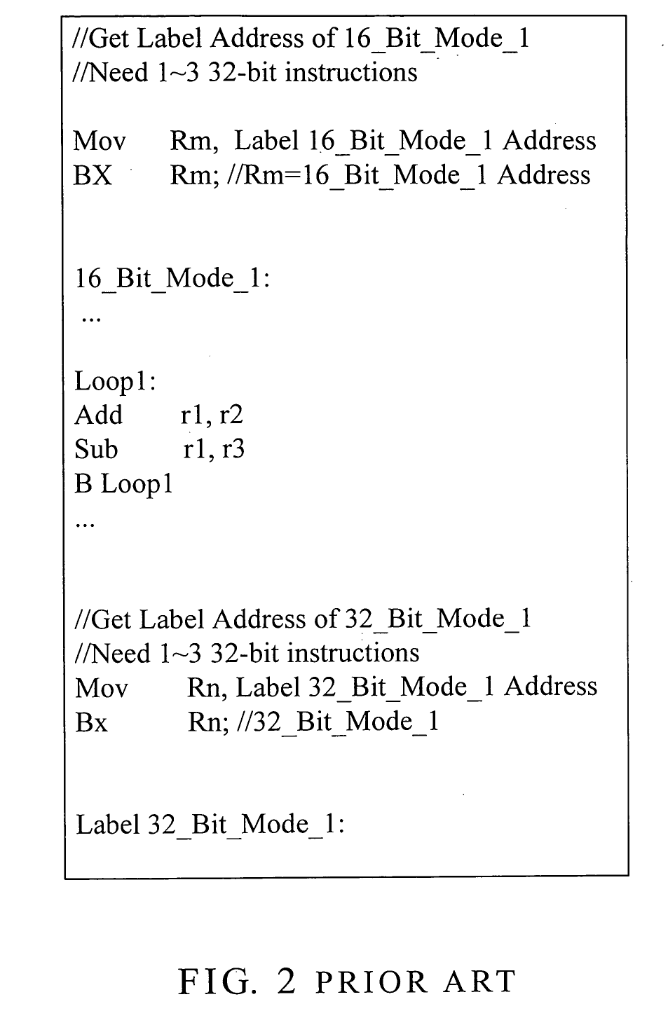

FIG. 3 is a schematic view of instruction formats of another typical instruction mode switching process;

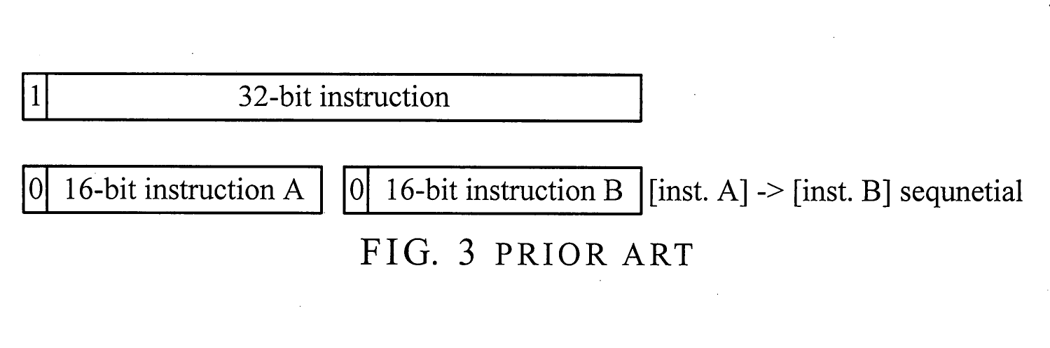

FIG. 4 shows an architecture of a processor for executing instruction sets with different lengths in accordance with the invention; and

FIG. 5 is a schematic diagram of a processor for executing instruction sets with different lengths at operation in accordance with the invention.

### DETAILED DESCRIPTION OF THE PREFERRED EMBODIMENT

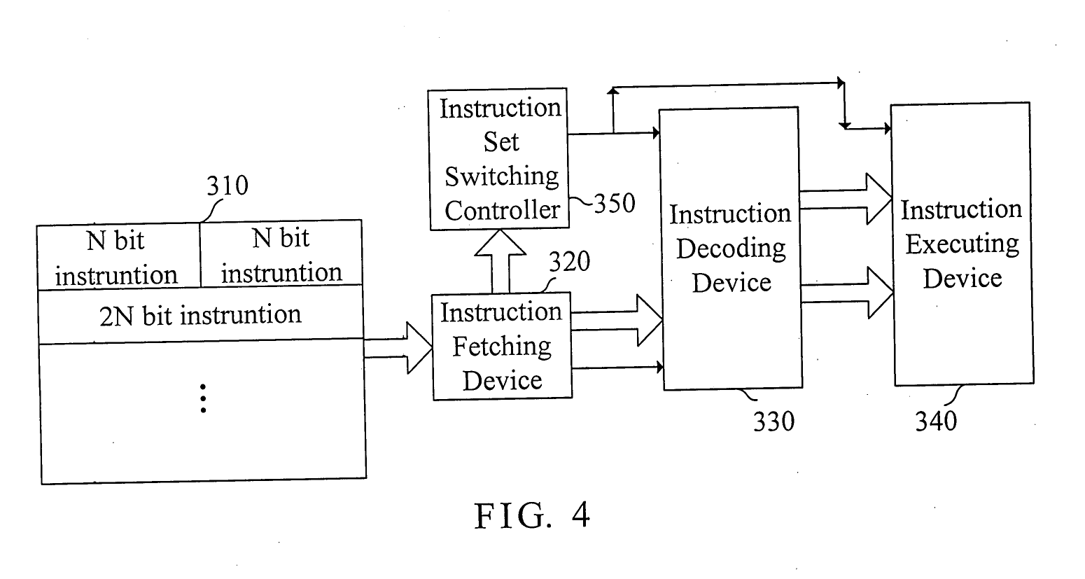

With reference to FIG. 4, there is shown an architecture of a processor capable of executing instruction sets with different lengths in accordance with the invention, which includes an instruction input device 310, an instruction fetching device 320, an instruction decoding device 330, an instruction executing device 340 and an instruction set switching controller 350. The instruction input device 310 is provided instructions to be executed by the processor. In this embodiment, the instruction sets with different lengths capable of being executed by the processor include an N-bit instruction set and a 2N-bit instruction set (N is positive integer). Each instruction of the N-bit instruction set consists of an N-bit word. Each instruction of the 2N-bit instruction set consists of a 2N-bit word. The 2N-bit instruction set includes an ISSI-2N-N (instruction set switch instruction-2N-N). The N-bit instruction set includes an ISSI-N-2N (instruction set switch instruction-N-2N). In this embodiment, N is preferred to be 16.

As shown in FIG. 4, the instruction input device 310 includes a memory space having a width of 2N=32 bits for storing a plurality of 2N-bit words representing instructions. Each 2N-bit word represents two N-bit instructions or a 2N-bit instruction. The instruction fetching device 320 fetches a 2N-bit word from the instruction input device 310. The instruction set switching controller 350 is coupled to the instruction fetching device 320 such that when the 2N-bit word fetched by the instruction fetching device 320 is an ISSI-2N-N, the instruction set switching controller 350 switches the instruction decoding device 330 and the instruction executing device 340 to be in an N-bit mode. In the N-bit mode, the fetched 2N-bit word from the instruction input device 310 represents two N-bit instructions. Thus, the instruction decoding device 330 decodes the fetched 2N-bit word as two N-bit instructions and the instruction executing device 340 executes the two decoded N-bit instructions in order.

When the 2N-bit word fetched by the instruction fetching device 320 is an ISSI-N-2N, the instruction set switching controller 350 switches the instruction decoding device 330 and the instruction executing device 340 to be in a 2N-bit mode. In the 2N-bit mode, the fetched 2N-bit word from the instruction input device 310 represents a 2N-bit instruction. Thus, the instruction decoding device 330 decodes the fetched 2N-bit word as a 2N-bit instruction and the instruction executing device 340 executes the decoded 2N-bit instruction.

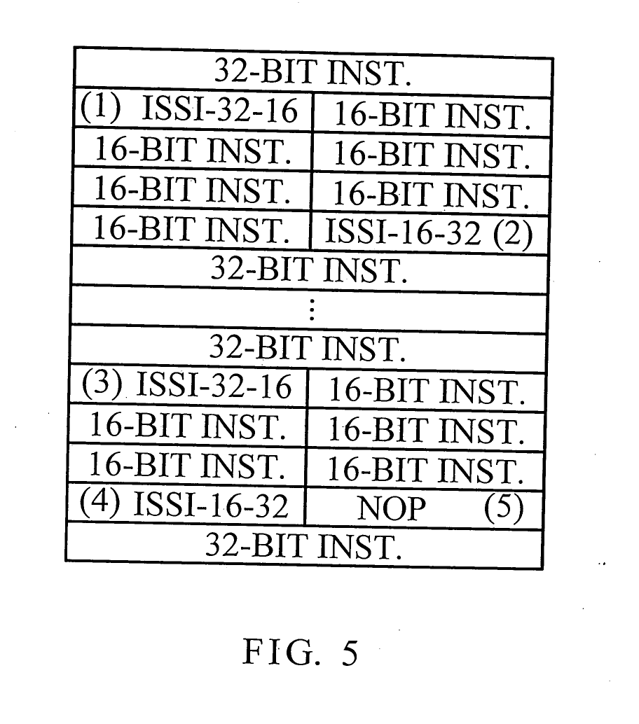

FIG. 5 shows a code segment for a program in accordance with the present invention. As shown, the ISSI-32-16 instruction (1) is located on the first 16-bit instruction of 32-bit boundary and second 16-bit of 32-bit boundary is 16-bit instruction. Also, the ISSI-16-32 instruction (4) is located on the first 16-bit instruction of 32-bit boundary and the following instruction is a 32-bit instruction, so that a NOP instruction (5) is inserted after instruction (4) in assembling.

When the instruction fetching device 320 fetchesinstruction (1), because instruction (1) is an ISSI-32-16 instruction (16/32 bits), the instruction set switching controller 350 switches the instruction decoding device 330 and the instruction executing device 340 to be in the 16-bit mode for execution. When the instruction fetching device 320 fetches instruction (2), becauseinstruction (2) is an ISSI-16-32 instruction, the instruction set switching controller 350 switches the instruction decoding device 330 and the instruction executing device 340 to be in the 32-bit mode for execution.

In this embodiment, the invention requires an ISSI-32-16 and an ISSI-16-32 only, i.e., with instructions (1) and (2) in a total of 16+16=32 bits, for executing a 32-bit to 16-bit and 16-bit to 32-bit mode switching program, i.e., with instructions (3), (4) and (5) at most in a total of 16+16+16=48 bits. Accordingly, it can save memory space when compared with the conventional mode switch solution that requires 96˜192 bits for the mode switch.

In addition, the format of the ISSI-32-16 can be the same as the format of the ISSI-16-32; i.e., both are an instruction set switch instruction (ISSI). As the ISSI is fetched each time, the instruction set switching controller 350 switches the execution mode for the instruction decoding device 330 and the instruction executing device 340. For example, when the ISSI is fetched at the first time, the instruction set switching controller 350 switches both the instruction decoding device 330 and the instruction executing device 340 to be in the 16-bit mode. When the ISSI is fetched again, the instruction set switching controller 350 switches both the instruction decoding device 330 and the instruction executing device 340 to be in the 32-bit mode, thereby saving one instruction encoding space.

This embodiment is given by taking a processor capable of executing instruction sets with two different lengths, i.e., an N-bit instruction set and a 2N-bit instruction set, as an example. However, in practice, the invention can also be applied to a processor capable of executing instruction sets with more than two lengths of instruction set. For example, the instruction sets with more than two (assumed to be M+1) lengths can be represented by 2ⁱ*N-bit instruction set (0≦i≦M, and N, M are positive integer). Instructions of the 2ⁱ*N-bit instruction set have a width of 2ⁱ*N-bit. The 2ⁱ*N-bit instruction set requires at least one 2ⁱ*N-bit to 2^{k}*N-bit instruction set switch instruction (0≦k≦M, and k≠i) for providing the instruction set switching controller 350 to switch the instruction decoding device 330 and the instruction executing device 340 from 2ⁱ*N-bit mode to 2^{k}*N-bit mode. In this case, the instruction input device 310 includes a memory space having a width of 2^{M}*N-bit for storing a plurality of 2^{M}*N-bit word representing instructions. The instruction fetching device 320 fetches a 2^{M}*N-bit word from the instruction input device 310. The instruction decoding device 330 decodes the 2ⁱ*N-bit word fetched by the instruction fetching device 320. The instruction executing device 340 executes the decoded 2ⁱ*N-bit instruction in order when the processor is in 2ⁱ*N-bit mode. The instruction set switching controller 350 switches the instruction decoding device and the instruction executing device to be in a 2^{k}*N-bit mode for execution when a 2ⁱ*N-bit to 2^{k}*N-bit instruction set switch instruction is fetched by the instruction fetching device 320. In the 2^{k}*N-bit mode, the instruction decoding device 330 decodes the fetched 2^{M}*N-bit word as at least one 2^{k}*N-bit instruction and the instruction executing device 340 executes the decoded at least one 2^{k}*N-bit instruction.

For example, when M=2 and N=16, the inventive processor can execute 64-/32-/16-bit instruction set and also includes an instruction set switch instruction-32-16 (ISSI-32-16), an ISSI-16-32, an ISSI-32-64, an ISSI-64-32, an ISSI-64-16 and an ISSI-16-64 in order to switch the executing modes of the processor. The ISSIs can also have the same format (ISSI) and obtain the same performance when the instruction set switching controller 350 changes execution modes of the instruction decoding device 330 and the instruction executing device 340 as the ISSI is fetched each time.

In view of the foregoing, it is known that the invention uses an ISSI-32-16 and an ISSI-16-32 to overcome the conventional problem in that 32-bit and 16-bit instructions cannot be mixed and stored in the same memory block. Accordingly, required instructions and storage space for mode switch can be reduced and memory space for program code is optimized. In addition, such a mode switch can overcome the problem in that return addresses of branch-and-link and jump-and-link instructions are limited by word boundary or 32-bit boundary in the prior art. Thus, such a mode switch does not need 1-bit to separate the 16-bit instruction from the 32-bit instruction in a processor instruction and thus can support immediate addressing mode of 16-bit instruction.

Although the present invention has been explained in relation to its preferred embodiment, it is to be understood that many other possible modifications and variations can be made without departing from the spirit and scope of the invention as hereinafter claimed.

1. A processor capable of executing instruction sets with different lengths, the instruction sets with different lengths including at least an N-bit instruction set and a 2N-bit instruction set (N is positive integer), each instruction of the N-bit instruction set consisting of an N-bit word, each instruction of the 2N-bit instruction set consisting of a 2N-bit/N-bit word, the 2N-bit instruction set including a 2N to N instruction set switch instruction, the N-bit instruction set including an N to 2N instruction set switch instruction, the processor comprising:
an instruction input device, which includes a memory space having a width of 2N-bit for storing a plurality of 2N-bit words representing instructions;
an instruction fetching device, which fetches a 2N-bit word from the instruction input device;
an instruction decoding device, which decodes the 2N-bit word fetched by the instruction fetching device and outputs an N-bit instruction or a 2N-bit instruction;
an instruction executing device, which executes the decoded N-bit instruction or the 2N-bit instruction; and
an instruction set switching controller, which is coupled to the instruction fetching device for switching the instruction decoding device and the instruction executing device to be in an N-bit mode for execution when the 2N to N instruction set switch instruction is fetched, or switching the instruction decoding device and the instruction executing device to be in a 2N-bit mode for execution when the N to 2N instruction set switch instruction is fetched,
wherein in the N-bit mode, the instruction decoding device decodes the 2N-bit word fetched by the instruction fetching device as two N-bit instructions and the instruction executing device executes the two N-bit instructions, and in the 2N-bit mode, the instruction decoding device decodes the 2N-bit word fetched by the instruction fetching device as a 2N-bit instruction and the instruction executing device executes the 2N-bit instruction.

2. The processor as claimed in claim 1, wherein N=4, N=16 or N=32.

3. The processor as claimed in claim 1, wherein the 2N to N instruction set switch instruction and the N to 2N instruction set switch instruction have the same instruction format, and the instruction set switching controller changes execution modes of the instruction decoding device and the instruction executing device at the instruction is fetched each time.

4. A method for executing instruction sets with different lengths in a processor, the instruction sets with different lengths including an N-bit instruction set and a 2N-bit instruction set (N is positive integer), each instruction of the N-bit instruction set consisting of an N-bit word, each instruction of the 2N-bit instruction set consisting of a 2N-bit word and the exception is ISSI-2N-N that can be N-bit or 2N-Bit, the 2N-bit instruction set including a 2N to N instruction set switch instruction, the N-bit instruction set including an N to 2N instruction set switch instruction, the method comprising the steps:
(A) providing a plurality of 2N-bit words representing instructions;
(B) fetching one of the plurality of 2N-bit words in order to be decoded by an instruction decoding device and executed by an instruction executing device;
(C) when the 2N to N instruction set switch instruction is fetched, switching the instruction decoding device and the instruction executing device to be in an N-bit mode for execution, such that the instruction decoding device decodes the fetched 2N-bit word as two N-bit instructions, and the instruction executing device executes the two N-bit instructions; and
(D) when the N to 2N instruction set switch instruction is fetched, switching the instruction decoding device and the instruction executing device to be in a 2N-bit mode for execution, such that the instruction decoding device decodes the one 2N-bit word fetched as a 2N-bit instruction and the instruction executing device executes the 2N-bit instruction.

5. The method as claimed in claim 4, wherein N=4, N=16 or N=32.

6. The method as claimed in claim 4, wherein the 2N to N instruction set switch instruction and the N to 2N instruction set switch instruction are the same instruction format, and the instruction set switching controller switches execution modes of the instruction decoding device and the instruction executing device at the instruction is fetched each time.

7. A processor capable of executing instruction sets with different lengths, the instruction sets with different lengths being represented by 2ⁱ*N-bit instruction set (0≦i≦M, and N, M are positive integer), instruction size of the 2ⁱ*N-bit instruction set is 2ⁱ*N-bit, the 2ⁱ*N-bit instruction set including at least one 2ⁱ*N-bit to 2^{k}*N-bit instruction set switch instruction (0≦k≦M, k≠i), the processor comprising:
an instruction input device, which includes a memory space having a width of 2^{M}*N-bit for storing a plurality of 2^{M}*N-bit words representing instructions;
an instruction fetching device, which fetches a 2^{M}*N-bit word from the instruction input device;
an instruction decoding device, which decodes the 2ⁱ*N-bit word fetched by the instruction fetching device (2^{M}*N-bit word) and outputs a 2ⁱ*N-bit instruction;
an instruction executing device, which executes the 2ⁱ*N-bit instruction; and
an instruction set switching controller, which is coupled to the instruction fetching device for switching the instruction decoding device and the instruction executing device to a 2^{k}*N-bit mode for execution when the 2ⁱ*N to 2^{k}*N instruction set switch instruction is fetched,
wherein in the 2^{k}*N-bit mode, the instruction decoding device decodes the 2^{k}*N bit word fetched by the instruction fetching device one 2^{M}*N-bit instruction and the instruction executing device executes the 2^{k}*N-bit instruction.

8. The processor as claimed in claim 7, wherein N=16 and M=2.

9. A method for executing instruction sets with different lengths in a processor, the instruction sets with different lengths being represented by 2ⁱ*N-bit instruction set (0≦i≦M, and N, M are positive integer), instruction set of the 2ⁱ*N-bit consists of one 2ⁱ*N-bit to 2^{k}*N-bit instruction set switch instruction (0≦k≦M, k≠i), the method comprising the steps:
(A) providing a plurality of 2^{M}*N-bit words representing instructions;
(B) fetching one of the plurality of 2^{M}*N-bit words in order to be decoded by an instruction decoding device and executed by an instruction executing device; and
(C) when the 2ⁱ*N to 2^{k}*N instruction set switch instruction is fetched, switching the instruction decoding device and the instruction executing device to a 2^{k}*N-bit mode for performance, such that the instruction decoding device decodes the one 2^{M}*N-bit word fetched as at least one 2^{k}*N-bit instruction and the instruction executing device executes the at least one decoded 2^{k}*N-bit instruction.

10. The method as claimed in claim 9, wherein N=16 and M=2.
